(19) United States
(12) Patent Application Publication
(10) Pub. No.: US 2024/0402118 A1
(43) Pub. Date: Dec. 5, 2024

(54) OBJECT AMOUNT DETECTION DEVICE

(71) Applicant: ALPS ALPINE CO., LTD., Tokyo (JP)

(72) Inventor: Takeshi MASAKI, Miyagi (JP)

(21) Appl. No.: 18/804,369

(22) Filed: Aug. 14, 2024

Related U.S. Application Data
(63) Continuation of application No. PCT/JP2022/046257, filed on Dec. 15, 2022.

(30) Foreign Application Priority Data
Feb. 25, 2022 (JP) 2022-028511

(51) Int. Cl. G01N 27/22

(52) U.S. Cl. CPC G01N 27/226

(57) ABSTRACT

An object amount detection device includes a container configured to contain a solidifiable liquid object, an electrode extending in a vertical direction in the container, and configured to allow for detection of a change in capacitance accompanying a positional change in the vertical direction of a liquid surface of the object or an exterior surface of the object having been solidified, and a processor configured to execute program instructions stored in a memory to detect continuously or intermittently, based on the capacitance of the electrode, a position of the liquid surface or the exterior surface of the object in the container, to obtain a permittivity of the object from the capacitance of the electrode, and to determine a state of the object based on the obtained permittivity.

### CROSS-REFERENCE TO RELATED APPLICATIONS

This application is a continuation application of International Application No. PCT/JP2022/046257 filed on Dec. 15, 2022 and designated the U.S., which is based upon and claims priority to Japanese Patent Application No. 2022-028511 filed on Feb. 25, 2022 with the Japanese Patent Office, the entire contents of which are hereby incorporated by reference.

### BACKGROUND OF THE INVENTION

### 1. Field of the Invention

The disclosures herein relate to an object amount detection device for a solidifiable liquid object, etc.

### 2. Description of the Related Art

Conventionally, an object amount detection device which detects an amount of water etc. is known, and the object amount detection device is provided in an ice making device and used. A conventional ice making device includes an ice tray which is formed of an insulator, a water-supply part for supplying water to the ice tray, an electrostatic capacitance sensor having two or more electrodes which are attached to the ice tray and are respectively insulated, a water amount detecting section for detecting a water amount in the ice tray which is supplied through the water-supply part on the basis of variation of an electrostatic capacitance between electrodes of the electrostatic capacitance sensor, and a drive part for turning and elastically deforming the ice tray to a state that an opening of the ice tray is directed downward after the water in the ice tray is detected to be frozen, and the electrodes of the electrostatic capacitance sensor are attached to an outer face of the ice tray through a displacement absorption member which is capable of being elastically deformed (see e.g. the Patent Literature (PTL) 1).

Note that, although the related object amount detection device used for an ice making device detects an amount of water and whether the water is frozen, it cannot determine to what extent the water is frozen or how much ice is there.

Therefore, the present embodiment aims to provide an object amount detection device which can determine the amount and the state of a solidifiable liquid object in a container.

### CITATION LIST

### Patent Literature

[PTL 1] Japanese Laid-Open Patent Publication No. 2012-207824

### SUMMARY OF THE INVENTION

An object amount detection device includes a container configured to contain a solidifiable liquid object, an electrode extending in a vertical direction in the container, and configured to allow for detection of a change in capacitance accompanying a positional change in the vertical direction of a liquid surface of the object or an exterior surface of the object having been solidified, and a processor configured to execute program instructions stored in a memory to detect continuously or intermittently, based on the capacitance of the electrode, a position of the liquid surface or the exterior surface of the object in the container, to obtain a permittivity of the object from the capacitance of the electrode, and to determine a state of the object based on the obtained permittivity.

An object amount detection device which can determine the amount and state of a solidifiable liquid object in a container can be provided.

### BRIEF DESCRIPTION OF THE DRAWINGS

FIG. 1 is a drawing illustrating a configuration of an object amount detection device 100 of the embodiment;

FIG. 2 is a drawing illustrating an electrostatic sensor 110;

FIG. 3 is a drawing illustrating one example of a result of a calculation of a height of a liquid surface;

FIG. 4 is a drawing describing a difference in a capacitance of the electrostatic sensor 110 according to a difference in a height of a surface of a washer liquid 20A;

FIG. 5A is a drawing illustrating the electrostatic sensor 110 used for a third correction method;

FIG. 5B is a drawing of a result of an actual measurement by the third correction method;

FIG. 6 is a drawing illustrating a sixth correction method;

FIG. 7 is a drawing illustrating a flowchart describing processes of detecting the surface height H and a state of freezing of the washer liquid 20A; and

FIG. 8 is a drawing describing a method to correct a variation in capacitance accompanying an inclination.

### DESCRIPTION OF THE PREFERRED EMBODIMENT

In the following, an embodiment of the present invention will be described with reference to the accompanying drawings.

### EMBODIMENT

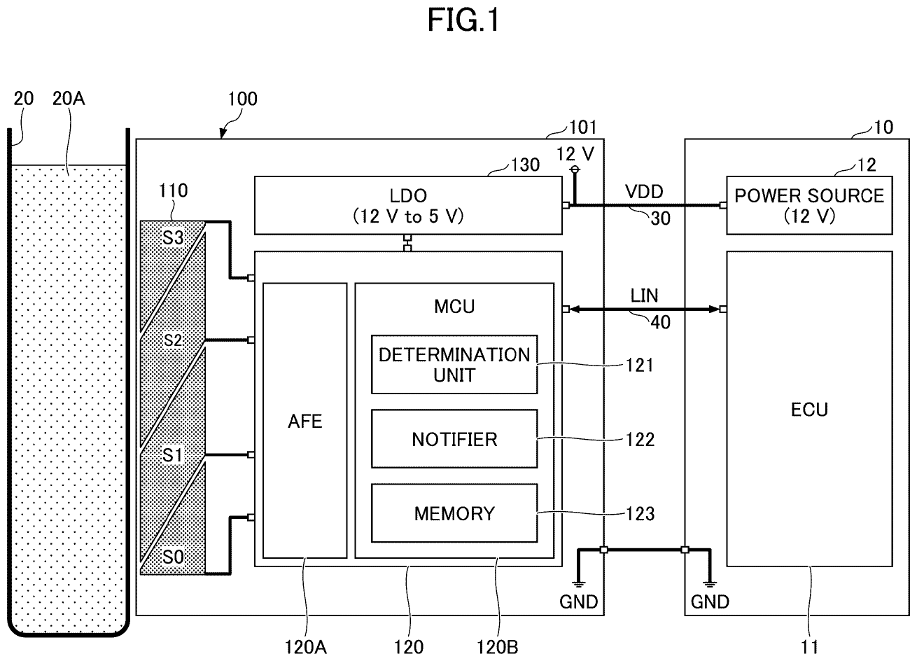

FIG. 1 is a drawing illustrating a configuration of an object amount detection device 100 of the embodiment. FIG. 1 shows a vehicle system 10 in addition to the object amount detection device 100. The vehicle system 10 includes an ECU (Electronic Control Unit) 11 and a power source 12. The vehicle system 10 is, as one example, a system to control electronic devices of the vehicle, and any type of electronic devices may be applicable. For example, ADAS (Advanced Driver-Assistance Systems) may be applicable. ECU 11 controls the vehicle system 10. The power source 12 supplies 12 V of direct current electric power from an electric power source, a battery of the vehicle, and the like.

The object amount detection device 100 is a device to detect an amount of a washer liquid 20A stored in a tank 20 for a vehicle washer liquid. Since when mud, dust, insects, etc. is adhered to a camera or an optical sensor provided with on a self-driving vehicle or a vehicle with an automatic driving function on which a vehicle system 10 such as ADAS is provided with, proper images or optical information cannot be obtained; accordingly, systems to clean the camera of the optical sensor by a washer liquid have been developed.

The vehicle system 10 detects the amount of the washer liquid 20A in the tank 20 in order to determine whether a safe drive is possible. Note that, when an outside air temperature is low, in winter as the like, the washer liquid may be frozen. If the washer liquid 20A is frozen, it may be unable to be sprayed as a liquid.

Therefore, the object amount detection device 100 detects a vertical position of a liquid surface of the washer liquid 20A, or the surface of the washer liquid 20A at the state that it is at least partially frozen, and determines whether the washer liquid 20A is frozen.

In the present embodiment, a state of the washer liquid 20A refers to whether the washer liquid 20A is in an unfrozen liquid state or a frozen state. The frozen state may refer to a completely frozen state, but it also may refer to a state in which the washer liquid 20A is difficult to spray from the tank 20. In the present embodiment, the frozen state refers to the state in which the washer liquid 20A is difficult to spray from the tank 20.

Moreover, the washer liquid 20A is one example of a solidifiable (freezable) liquid object. Hereinafter, the washer liquid 20A may refer to not only a liquid state, but also a solid state, or a mixture of a liquid and a solid. Moreover, a surface height of the washer liquid 20A refers to the vertical position of the liquid surface of the washer liquid 20A in the liquid state, or the vertical position of the surface of the washer liquid 20A in the frozen state.

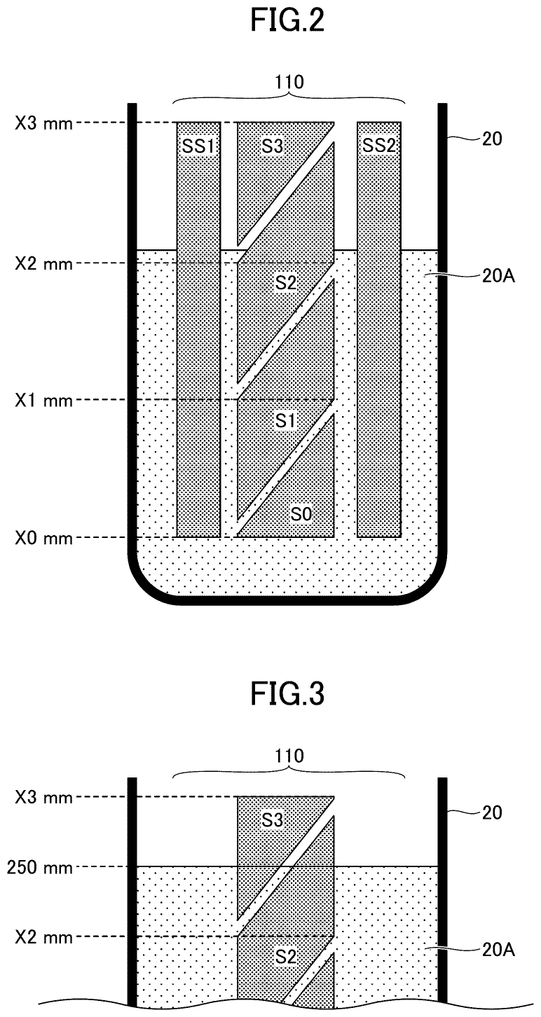

The object amount detection device 100 includes a control board 101, an electrostatic sensor 110, an IC (Integrated Circuit) chip 120, and an LDO (Low Dropout) 130. As one example, the electrostatic sensor 110, the IC chip 120, and the LDO 130 are disposed on one control board 101, but they may be disposed on different t control boards, etc. The control board 101 is a wiring substrate. Moreover, the electrostatic sensor 110 is described using FIG. 2 in addition to FIG. 1. FIG. 2 is a drawing illustrating an electrostatic sensor 110, and illustrates a front view of the electrostatic sensor 110.

As shown in FIG. 2, the electrostatic sensor 110 is configured to have electrodes S0, S1, S2, S3, SS1, and SS2 on an insulated substrate (not shown), and attached to an outer surface of the tank 20 by a tape or an adhesive, etc. FIG. 1 is a simplified drawing in which the electrodes SS1 and SS2 are omitted. As shown in FIG. 1, the electrostatic sensor 110 is provided to extend across the vertical direction on a lateral wall of the tank 20, in order to enable to detect the liquid surface which varies vertically. Shapes of the electrodes S0, S1, S2, S3, SS1, and SS2 shown in FIG. 2 are the shapes of the surfaces disposed to the lateral surface of the tank 20. The electrodes S0, S1, S2, S3, SS1, and SS2 are plate-shaped electrodes.

The electrodes S0, S1, S2, S3, SS1, and SS2 are capacitively coupled with a metallic part (ground part) of a ground potential of a vehicle body and the like, on which the vehicle system 10 and the object amount detection device 100 are mounted. Hereinafter, capacitances of the electrodes S0, S1, S2, S3, SS1, and SS2 refer to the values of electrostatic capacitances between the electrodes S0, S1, S2, S3, SS1, and SS2 and the ground part of the vehicle.

The electrodes S0, S1, S2, S3, SS1, and SS2 are connected to the IC chip 120. The electrodes S0, S1, S2, and S3 are provided to detect a vertical position of the liquid surface of the washer liquid 20A, and detect the state of the washer liquid 20A. The electrodes SS1 and SS2 are provided to be used for the correction of the capacitances of the electrode S0, S1, S2, and S3.

The electrodes S0, S1, S2, and S3 are arranged in this order from the downside to the upside. The electrodes S0, S1, S2, and S3 are shaped to divide a rectangle whose shape of the surface is vertically elongated and which is disposed on the lateral surface of the tank 20, by three parallel oblique straight lines. The lowermost and the uppermost straight lines of the three respectively pass through a highest vertex and a lowest vertex of the rectangle, and the longitudinal center of the one middle straight line passes through the center of the rectangle.

Both the electrodes S0 and S3 have triangular surfaces to be disposed in the lateral surface of the tank 20, and they correspond in shape. The triangles of the electrodes S0 and S3 are the triangles which are obtained by dividing a quadrilateral by its diagonal.

The electrodes S1 and S2 correspond in shape as surfaces to be disposed in the lateral surface of the tank 20, and they are parallelograms which are obtained by combining the shapes of the two electrodes of the electrode S0 and S3. Therefore, the electrodes S1 and S2 contain two triangles which are obtained by dividing a quadrilateral by its diagonal. The heights of the lower end of the electrode S0 and the lower end of the electrode S1 are equal, and they are positioned higher than the lower end of the tank 20. The heights of the upper end of the electrode S3 and the upper end of the electrode S2 are equal, and they are positioned lower than the upper end of the tank 20. The heights of the lower end of the electrode S0 and the lower end of the electrode S1 are referred to as X0, and the heights of the upper end of the electrode S3 and the upper end of the electrode S2 are referred to as X3. When the surface height of the washer liquid 20A in the tank 20 is between X0 and X3, the surface of the washer liquid 20A always coincides with two of the electrodes S0-S3. Therefore, the electrodes S0 and S1, which neighbor vertically, are one example of an electrode pair, the electrodes S1 and S2 are one example of an electrode pair, and the electrodes S2 and S3 are one example of an electrode pair. Moreover, the details of the heights X0-X3 are described hereinafter. Furthermore, between the spaces electrodes S0 and S1, between the electrodes S1 and S2, and between the electrodes S2 and S3 are formed sufficiently small such that they can be ignored in actual measurement while ensuring insulation.

The IC chip 120 is a chip member having an AFE (Analog Front End) 120A and an MCU (Micro Computer Unit) 120B. The IC chip 120 is connected to the ECU 11 of the vehicle system 10, as one example, through a communication cable 40 for an LIN (Local Interconnect Network).

The AFE 120A is connected to the electrodes S0, S1, S2, S3, SS1, and SS2 of the electrostatic sensor 110, and digitally converts the capacitances of the electrodes S0, S1, S2, S3, SS1, and SS2 and outputs the capacitances to the MCU 120B. Moreover, an application of voltage to the electrodes S0, S1, S2, S3, SS1, and SS2 of the electrostatic sensor 110 is carried out by applying alternating current voltage from a not-illustrated power source, or a not-illustrated shield electrode, and coupling capacitively to the shield electrode.

The MCU 120B is realized by a computer including a CPU (Central Processing Unit), a RAM (Random Access Memory), a ROM (Read Only Memory), an input-output interface, an internal bus and the like.

The MCU 120B has a determination unit 121, a notifier 122, and a memory 123. The determination unit 121 and the notifier 122 represent the functions of the programs which the MCU 120B carries out as function blocks. Furthermore, the memory 123 represents the function of the memory of the MCU 120B. Moreover, descriptions of other processing parts of the MCU 120B except for the determination unit 121 and the notifier 122 are omitted here.

The determination unit 121 detects the height of the liquid surface of the washer liquid 20A, or the surface of the washer liquid 20A at the state that it is at least partially frozen, as a continuous or intermittent value of height. Moreover, the determination unit 121 determines whether the washer liquid 20A is frozen according to the detected surface height, the relative permittivity at the frozen state of the washer liquid 20A, and the capacitance of the electrostatic sensor 110. In order to determine whether the washer liquid 20A is frozen, a difference between the relative permittivity (80.4) at the liquid state and the relative permittivity (4.2) at the frozen state of the washer liquid 20A is utilized.

When the height of the washer liquid 20A is found, the determination unit 121 finds the height of the center of gravity of the washer liquid 20A, and finds the height of the liquid surface of the washer liquid 20A by doubling the height of the center of gravity. The determination unit 121 uses the heights X0-X3 shown in FIG. 2 when it finds the height of the center of gravity of the washer liquid 20A.

X0 refers to the height of the lower end of the electrode S0, X1 refers to the height of the vertical center of the electrode S1, X2 refers to the height of the vertical center of the electrode S2, and X3 refers to the height of the upper end of the electrode S3. As one example, when the height from the lower end to the upper end of the electrodes S0−S3 is 300 mm, X0=0 mm, X1=100 mm, X2=200 mm, and X3=300 mm, and the values of X0−X3 are fixed.

The determination unit 121 finds the height H of the washer liquid 20A by the following formula (1).

$$[ Formula 1 ]$$

$$H = 2 \times Σ ( {X}_{n} \times {A}_{n} ) / Σ {A}_{n} \qquad ( 1 )$$

In Formula 1, Xₙ refers to the X0-X3. Aₙ refers to the electrostatic capacitances of the electrodes S0, S1, S2, and S3.

Subsequently, a meaning of Formula 1 is described. First, the values of the electrostatic capacitance of the respective electrodes are proportional to vertical areas of the liquids or solids which the respective electrodes come in contact with. Moreover, the vertical areas are proportional to the masses of the liquids or solids within the vertical range of the respective electrodes. That is, the values of the electrostatic capacitance of the respective electrodes correspond to the masses of the liquids or solids within the range corresponding to the respective electrodes. Note that, a position of a center of gravity can be generally found by a weighted average of masses and distances of respective elements. Therefore, the center of gravity of the liquid or the solid can be found by a weighted average of capacitances (corresponding to masses) and distances of respective electrodes (Σ(Xₙ×Aₙ)/ΣAₙ). Moreover, since the height of the liquid or the solid is twice as high as the position of the center of gravity (Σ(Xₙ×Aₙ)/ΣAₙ), the surface height can be found by Formula 1.

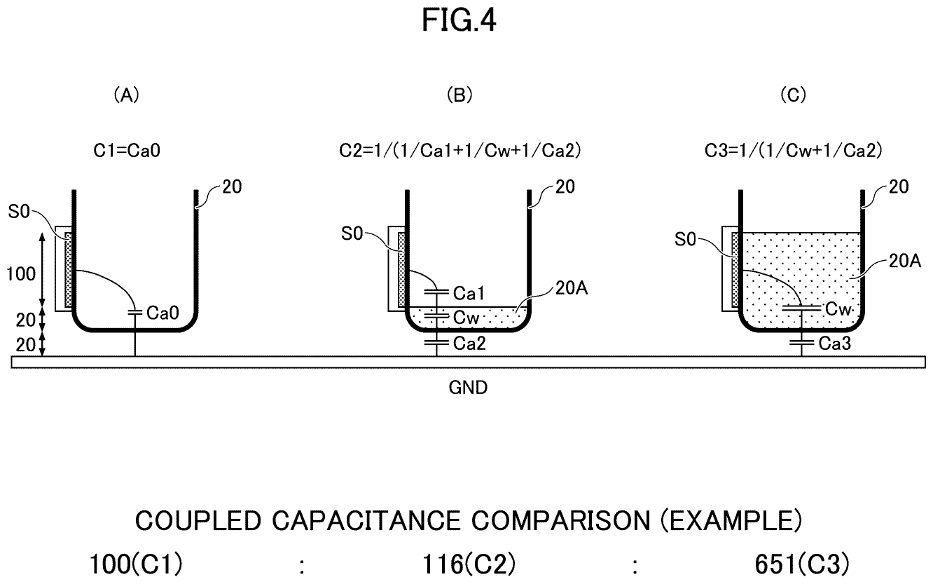

Subsequently, an example of a result of an actual calculation of the height of the liquid surface in a case when the washer liquid is liquid using Formula 1 is shown, and that the height of the liquid surface can be actually found by Formula 1 is described. FIG. 3 is a drawing illustrating one example of the result of the calculation of the height of the liquid surface. Table 1 is a drawing illustrating an example of the result of the calculation of the height of the liquid surface.

Example 1 is shown in Table 1, assuming that the liquid surface is located at the height of 250 mm as shown in FIG. 3. In Table 1, four results of calculations in addition to Example 1 are shown.

TABLE 1

| | Assumed | | | | | Calculated |
|---|---|---|---|---|---|---|
| | Liquid Surface | S0 | S1 | S2 | S3 | Liquid Surface |
| | Height (mm) | (pF) | (pF) | (pF) | (pF) | Height (mm) |
| | 0 | 0 | 0 | 0 | 0 | 0 |
| | 100 | 50 | 50 | 0 | 0 | 100 |
| Example 1 | 250 | 50 | 100 | 87.5 | 12.5 | 250 |
| | 280 | 50 | 100 | 98 | 32 | 280 |
| | 300 | 50 | 100 | 100 | 50 | 300 |

Since the relative permittivity of the washer liquid is similar to water and sufficiently higher than a permittivity of air, the capacitances measured in the respective electrodes are proportional to the areas of the electrodes immersed in the liquid. Assuming that when the entire electrode S0 is immersed in the liquid, the capacitance is 50 pF; in Example 1, S0 and S1 are entirely immersed in the liquid, and the area of the electrode S1 is twice as large as that of the electrode S0, therefore S0=50 pF and S1=100 pF are measured. Moreover, in the electrode S2, the value corresponding to the range 100-200 mm is 50 pF, and the capacitance corresponding to the area of the range 200-250 mm is 50 pF×(1−½×½)=37.5 pF, that is, the capacitance of the electrode S2 is 50+37.5=87.5 pF. The capacitance of the electrode S3 is, as an area corresponding to the range 200-250 mm, 50 pF×(C½×½)=12.5 pF.

Moreover, by calculating the height of the liquid surface, using Formula 1, according to the measured values of the respective electrodes to be measured, H=2×(0×50+0+200×87.5+300×12.5)/(50+100+87.5+12.5)=250 mm is found, and coincides with the assumed height of the liquid surface of Example 1. Thus, the height of the liquid surface can be found from the capacitances of the respective electrodes.

Similarly, results of finding capacitances of respective electrodes changing an assumed height of the liquid surface, and examples of the results of the calculations of the height of the liquid surface found from the capacitances of these respective electrodes are shown in Table 1. As is clear from Table 1, the assumed height of the liquid surface coincides with the height of the liquid surface calculated from the capacitances, and it is confirmed that the height of the liquid surface can be found from Formula 1. Moreover, since the capacitance is proportional to the permittivity, as is clear from Formula 1, even if the permittivity changes, the calculated value itself of H does not change. Note that, when all of the capacitances of the electrodes S1, S2, and S3 are zero, although the denominator of Formula 1 becomes zero, the water level height is zero in this case.

Furthermore, the determination unit 121 determines whether the washer liquid 20A is frozen or liquid, by the following Formula 2, according to the detected surface height, the capacitance of the electrostatic sensor 110, and the relative permittivity of the washer liquid 20A at the frozen state or the liquid state. A coefficient C is configured considering the relative permittivity of the washer liquid 20A at the liquid state or the frozen state. The value of the coefficient C may be configured by determining to what extent the washer liquid 20A is frozen when it becomes difficult to be sprayed, according to a shape or a volume of the tank 20. That is, since the capacitance is proportional to the permittivity, there are few capacitances to be measured according to the surface height, and when Formula 2 is applicable, the determination unit 121 determines that the washer liquid 20A is frozen assuming the permittivity to be low.

Moreover, a relative permittivity of water is 80.4, and a relative permittivity of ice is 4.2, and the relative permittivities of the washer liquid 20A at the liquid state and the frozen state are similar to these respective values. And thus, since values of a relative permittivity vary largely between at a liquid state and a frozen state, a proper configuration of the coefficient C enables easily to determine whether the washer liquid 20A is frozen.

$$[ Formula 2 ]$$

$$H \times C ≧ Σ A ( n ) \qquad ( 2 )$$

Moreover, similarly, determining whether the state is liquid by confirming whether the capacitance to be measured according to the surface height is larger than that of at a frozen state may also be applicable. Furthermore, by determining a threshold properly, the state is also possible to determine a state still in progress, for example a sherbet-like state during a change from liquid to solid.

The notifier 122 notifies data referring to the surface height H of the washer liquid 20A calculated by the determination unit 121 to the ECU 11 of the vehicle system 10. Moreover, when the determination unit 121 determines that the washer liquid 20A is frozen, the notifier 122 notifies data referring to the freezing to the ECU 11 of the vehicle system 10.

The memory 123 stores the data of the capacitances of the electrodes S0, S1, S2, S3, SS1, and SS2, and the heights of X0-X3, and the surface height H of the washer liquid 20A, and the like. In order to find a moving average of the height H, or to refer to the results of determination of the past five seconds representing continuous freezing, the memory 123 stores the data of the height H found in the past, the data of the results of the past determination, or the like.

The LDO 130 is connected to the power source 12 of the vehicle system 10 through a power cable 30. The LDO 130 is a regulator that can output a fixed voltage lower than an inputted voltage, and a power supply IC. The LDO 130 lowers the voltage of the direct current power supplied from the power source 12 of the vehicle system 10, from 12 V to 5 V, and supplies the power to the MCU 120B.

Subsequently, corrections are described. Moreover, corrections are not always necessary.

### <First Correction Method>

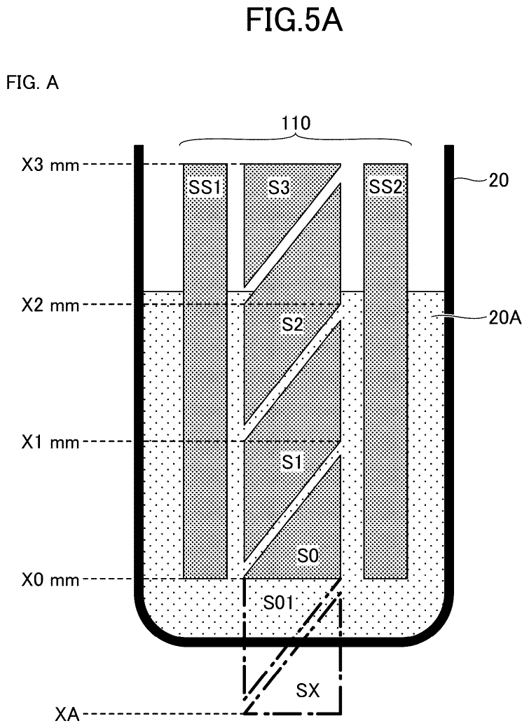

First, a first correction method is described. As described above, the water level height is basically found by Formula 1, but since the denominator of Formula 1 is a sum of the measured values of each electrode, particularly in the case that all the measured values are small, that is in the case that the water level is low, there is a problem that a variation between the calculated value of the surface height and the actual surface height becomes large, and it is a problem to be solved when a highly accurate detection is required. One of the causes is capacitance C2 caused by water that is present below a measuring range of the sensor. That is, capacitances of each electrode should primarily be zero in a range below a measuring range of the sensor, but actually the capacitance C2 caused by the water below a measuring range is measured. Thus, the capacitance used to measure the water level actually is required to be a value in which C2 is subtracted from the measured value. Moreover, a correction of the electrode S0, which is carried out for a correction in the range of the low water level, is described as mentioned above, and a corresponding correction may be carried out in the electrode S1. Hereinafter, a description is performed using FIG. 4.

FIG. 4 is a drawing describing a difference in a capacitance of the electrostatic sensor 110 according to a difference in a surface height of the washer liquid 20A. Moreover, illustrations of the electrodes S0, S1, S2, S3, SS1, and SS2 are omitted. In an example shown in FIG. 4(A), a vertical distance between a ground part GND to the tank is configured to be 20 mm, a vertical distance between a bottom of the tank 20 to the lower end of the electrode S0 is configured to be 20 mm, and a vertical distance between the lower end to the upper end of the electrode S0 is configured to be 100 mm. This is the same in FIG. 4(B) and FIG. 4(C).

In FIG. 4(A), the washer liquid 20A is not contained in the tank 20. In this case, capacitance C1 between the electrode S0 and the ground part GND, ignoring a thickness of the tank 20, can be considered to be equal to capacitance Ca0 of the case when there exists air between the electrode S0 and the ground part GND, and can be approximated by Ca0=1×ε0×S/140. The value of 1 which is multiplied with 20 is a relative permittivity of the air. S refers to surface areas of the electrodes S0-S3 of the electrostatic sensor 110. A reference numeral 140 denotes the distance between the GND and the electrode S0.

In FIG. 4(B), the surface height of the washer liquid 20A (liquid state) in the tank 20 is as high as the lower end of the electrode S0. In this case, capacitance C2 between the electrode S0 and the ground part GND is a sum of capacitance Ca1 of the upper part higher than the washer liquid 20A, capacitance Cw of the inner part of the washer liquid 20A, and capacitance Ca2 of a part between the tank 20 and the ground part GND. They can be approximated as Ca1=1×20×S/100, Cw=80.4×ε0×S/20, and Ca2=1×20×S/20. The value 80.4, which is multiplied with 80 with respect to Cw, is a relative permittivity of the washer liquid 20A at a liquid state.

In FIG. 4(C), the surface height of the washer liquid 20A (liquid state) in the tank 20 is as high as the upper end of the electrode S0. In this case, capacitance C3 between the electrode S0 and the ground part GND is a sum of capacitance Cw of the inner part of the washer liquid 20A, and capacitance Ca3 of a part between the tank 20 and the ground part GND. They can be approximated as Cw=80.4×ε0×S/120, and Ca3=1×ε0×S/20.

Consequently, a ratio of the capacitance C1 between the electrode S0 and the ground part GND at the state shown in FIG. 4(A), capacitance C2 between the electrode S0 and the ground part GND at the state shown in FIG. 4(B), and the capacitance C3 between the electrode S0 and the ground part GND at the state shown in FIG. 4(C) is 100:116:651.

When the surface of the washer liquid 20A is higher than the lower end of the electrode S0, a variation of the capacitance according to the water level of the washer liquid 20A is considered to be appropriately detected, but when the surface of the washer liquid 20A is lower than the lower end of the electrode S0, since the washer liquid 20A and the electrode S0 do not coincide vertically, a value measured at the electrode S0 is supposed to have a large error, and the water level found by Formula 1 is also supposed to have a large error. Therefore, when the capacitance measured in the electrode so is equal to or larger than the capacitance of the state in which the tank 20 does not contain water, the correction is carried out here.

Specifically, when the capacitance of C1 is referred to as k×100 (k is a constant) F, C2 is k×116F, and C3 is k×651F. Note that, since C3 is the largest capacitance measured by the electrode S0 here, it is 500 pF. Therefore, in this example, k=0.77, C1=77 pF, C2=89 pF, and C3=500 pF. Furthermore, when the capacitance of the electrode S0 is between C1 and C2, that is, from the state without washer liquid 20A to the state in which the surface is as high as the lower end of the electrode S0, the measured value is reduced and the capacitance of the electrode S0 is corrected to zero. Moreover, when the value of the electrode S0 is over C2 and equal to C3 or less, that is, the washer liquid 20A level is as high as from the lower end of the electrode S0 to the upper end of the electrode S0 or more, the measured value of the electrode S0 is corrected by subtracting C2.

Moreover, when the measured value of the electrode S0 is C2 or less, a correction to make the value zero may be carried out, and when it exceeds C2, a correction to subtract C2 may be carried out. Furthermore, a similar correction may also be carried out in the electrode S1. Moreover, when the value of the electrode S0 is over C2 and equal to C3 or less, since if only a simple correction to subtract C2 was carried out, the maximum capacitance would then become C3-C2; accordingly, when the value of the electrode S0 exceeds C2, a correction to subtract C2 from the value and multiply the resulting value by C3/(C3-C2) may be carried out. Furthermore, the water level is found by Formula 1 and the freezing state of the washer liquid is determined by Formula 2, using the values which are thus corrected measured values.

### <Second Correction Method>

Subsequently, a second correction method which is used in case the water level is low is described. In this correction method, an electrode is extended below the water level measuring region. That is, in examples shown in FIG. 4(A)-(C), a vertical distance between a bottom of the tank 20 to the lower end of the electrode S0 is 20 mm, and there are no electrodes, but in this method, the electrode S0 is extended and provided in the range. Thus, even if the surface of the washer liquid 20A is positioned 20 mm from the bottom of the tank 20 as shown in FIG. 4(B), the capacitance of the electrode S0 can be increased. Subsequently, the actual height of the liquid surface from X0 may be found by finding a distance between the bottom of the tank 20 and the surface of the washer liquid, and subtracting 20 mm from the found surface height. Thus, the measuring accuracy within the measuring region can be improved.

### <Third Correction Method>

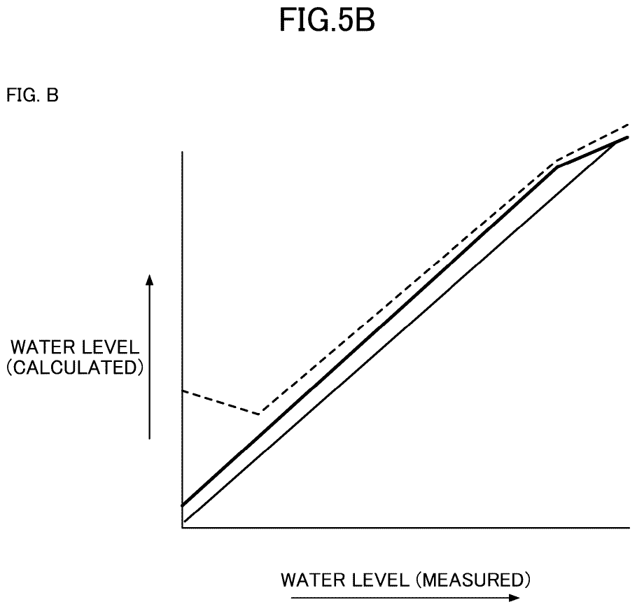

Subsequently, a third correction method which is used in case the water level is low is described. Although the second correction method is a method in which an electrode is actually provided, in the third method, an electrode is not actually provided and a similar process to the second correction is carried out by a calculation. FIG. 5A is a drawing illustrating the electrostatic sensor 110 used for the third correction method.

Specifically, as shown in FIG. 5A, virtual electrodes S01 and SX, which have the same shape as the electrodes S1 and S0 within the height X0-X1 are provided, the value of the capacitance of the electrode S01 which is found by the calculation corresponding to the washer liquid between the height XA and the height X0, is added to the actually measured value of the electrode S0, and the capacitance of the electrode SX corresponding to the washer liquid between the height XA and the height X0 is found. Moreover, the surface height from XA is found by Formula 1. Moreover, the actual surface height from X0 is found by subtracting the height between the height XA and the height X0 from the found surface height. Thus, the measuring accuracy can be heightened because the denominator of Formula 1 can be increased in the measuring region of the water level.

FIG. 5B is a drawing of the result of the actual measurement by the third correction method. In FIG. 5B, the horizontal axis represents the actual water level, and the vertical axis represents the calculated water level found by calculations from the actually measured data of each electrode. The thin solid line represents the ideal values in which the calculated values coincide with the actual water level, the dotted line represents the calculated values of the water level without correction, and the thick solid line represents the results of calculating the water level by the third correction method. In the part of the low water level, the values of the actual water level and the calculated values virtually coincide.

### <Fourth Correction Method>

As a fourth correction method, the water level may be detected by carrying out a y correction with an exponent larger than one, such as two, in order to perform correction by which a smaller capacitance is reduced by a greater amount compared to a larger capacitance. Thus, the effect of the electrode within the range in which the washer liquid exists is increased. Moreover, in such cases, the y correction may be applied only to the range of the low water level, instead of applying to the measurement of the surface height in the entire measurement region.

### <Fifth Correction Method>

Subsequently, since even if the washer liquid is not contained, the respective electrodes represent a predetermined value because of the effects of a stray capacity, errors occur in the calculations, and a fifth correction method is described as the correction method for the errors.

The fifth correction method is a method to correct all the values of electrodes S (n+1), S (n+2), and S (n+3) to zero, when the value of an electrode Sn is a predetermined value or less. That is, when the value of the electrode Sn is a predetermined value or less, the surface is positioned near the lower end of the electrode Sn; thus, the electrodes S (n+1), S (n+2), and S (n+3), which are positioned higher than the electrode Sn, are determined not to be immersed in the washer liquid; accordingly, an effect of capacitances being measured at the state in which the washer liquid is not contained can be reduced, by correcting the capacitances to zero.

### <Sixth Correction Method>

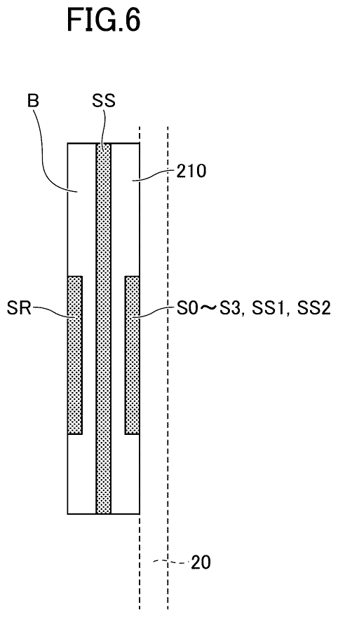

Subsequently, a sixth correction method which has the same purpose as the fifth correction method is shown. In the sixth correction method, the electrostatic sensor 210 shown in FIG. 6 is used. FIG. 6 is a drawing illustrating the sixth correction method, and a cross section of the electrostatic sensor 210.

Moreover, members corresponding to that of the electrostatic sensor 110 are denoted with the same reference numerals and described. Furthermore, although the electrode denoted as S0-S3, SS1, and SS2 is actually composed of separate members, and, also, a reference electrode SR is composed of a plurality of separate portions, these electrodes are each shown as one member in FIG. 6. The reference electrode SR is one example of reference electrodes. The electrostatic sensor 210 differs from the electrostatic sensor 110 in that the reference electrode SR and the shield electrode SS are provided, and this aspect is included in the following description.

Same as the electrostatic sensor 110, the electrodes S0-S3, SS1, and SS2 are formed on the same surface of the substrate B and disposed facing the tank 20. The reference electrode SR has a same shape as the electrodes S0-S3, SS1, and SS2, and provided on an opposite surface to the surface on which the electrodes S0-S3, SS1, and SS2 are provided. The shield electrode SS is provided in a thickness direction of the substrate B between the electrodes S0-S3, SS1, and SS2, and the reference electrode SR. The shield electrode SS is capacitively coupled with the electrodes S0-S3, SS1, SS2, and the reference electrode SR by connecting to the ground, or by being driven by alternating current. Therefore, although the capacitances of the electrodes S0-S3, SS1, and SS2 are affected by the washer liquid 20A in the tank 20, the electrode SR is not affected by the washer liquid 20A.

Subsequently, a correction is performed that subtracts the capacitances of the portions of the reference electrode, which have the same shape as the corresponding electrodes S0-S3, SS1, and SS2, from the capacitances of these electrodes. Thus, the capacitance caused by the existence of the washer liquid 20A can be found. That is, although a predetermined capacitance is measured and it varies according to a temperature variation without the washer liquid, the effect can be reduced. Moreover, the water level is found by applying the corrected value to Formula 1, and whether it is frozen is determined by Formula 2.

Note that, in the present example, the reference electrode has the same shape as the electrodes S0-S3, SS1, and SS2, but this is not limited, for example, it may be one electrode with different area. In this case, a value to be subtracted from the measured value is found by converting into the areas of electrodes S0-S3.

Moreover, in the present example, the shield electrode SS is disposed between the reference electrode SR and the electrodes S0-S3, SS1, and SS2 across an insulated layer of the substrate B, furthermore, another shield electrode may be disposed on the opposite surface to the electrodes S0-S3, SS1, and SS2 of the reference electrode SR across an insulated layer of the substrate B. That is, the reference electrode SR may be interposed between the two shield electrodes across the insulated layers of the substrate.

Moreover, the correction of the washer liquid 20A at the lower end of the electrode shown in FIG. 4 and below may be carried out after carrying out the correction using the electrostatic sensor 210.

Note that, a combination of one of the first to fourth corrections and one of the fifth and sixth corrections can be carried out, and in this case, any of the first to fourth corrections is carried out after carrying out any of the fifth and sixth corrections. Furthermore, if it is possible, a combination of corrections may be applied.

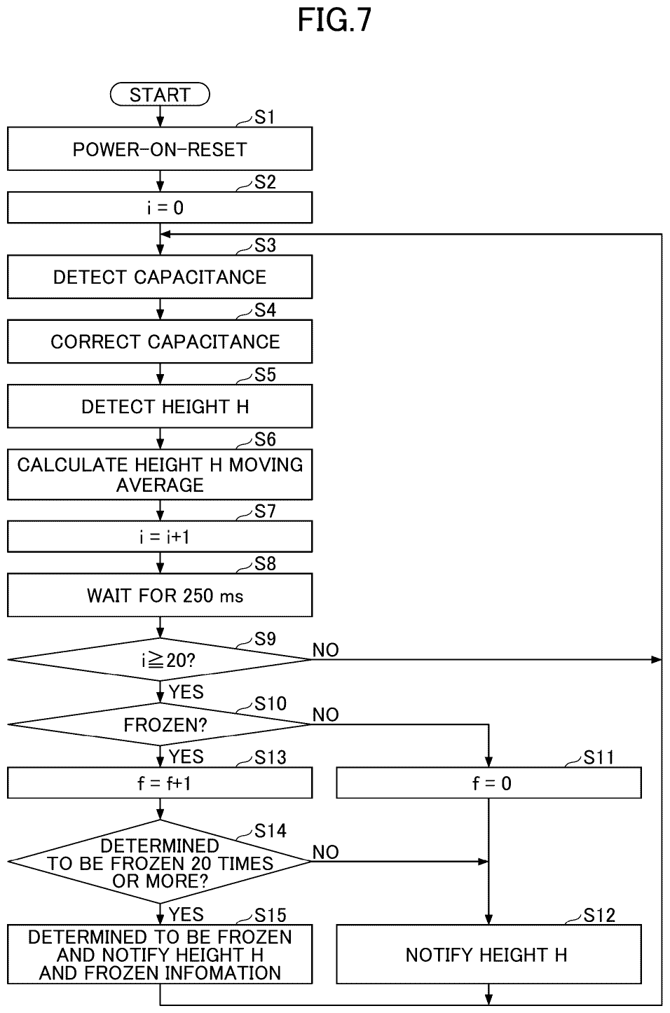

FIG. 7 is a drawing illustrating a flowchart describing processes of detecting the surface height H and the state of freezing of the washer liquid 20A in the electrostatic sensor 110 or the electrostatic sensor 210. These processes are carried out by the determination unit 121. Note that, although the processes by the determination unit 121 in the electrostatic sensor 110 and the electrostatic sensor 210 are different, corresponding processes are denoted with the same reference numerals.

When the determination unit 121 starts the processes, a power-on-reset process is carried out (a step S1). Specifically, a process to reset values of the ROM or the RAM or the like is carried out.

The determination unit 121 configures a count value i referring to a number of detections of the heights H to zero (i=0) (a step S2).

The determination unit 121 detects the capacitances of the electrode S0-S3 (a step S3).

With regard to the electrostatic sensor 110, the determination unit 121 carries out the above-mentioned fifth correction, and subsequently the above-mentioned first correction, that is, when the capacitance of the S0 is 77-89 pF, the value is corrected to zero, and when the value exceeds this range of 77-89 pF, a correction to subtract 89 pF is carried out (a step S4). In this case, as mentioned above, in the first correction, a corresponding correction may be carried out in the electrode S1.

Moreover, with regard to the electrostatic sensor 210, the above-mentioned sixth correction and the above-mentioned first correction are carried out (a step S4).

Note that, as mentioned above, a correction itself is not always necessary according to the required accuracy, and a correction may be either one of the above-mentioned correction methods or a combination of them.

The determination unit 121 calculates the height H according to Formula 1 (a step S5). Calculating the height H according to Formula 1 is equal to detecting the height H.

The determination unit 121 calculates a moving average of the height H calculated in the step S5, and the height H calculated in the past 19 times (a step S6). The moving average can be found by the Formula 3 below. However, j is an integer from 1 to 20, referring to the twenty heights H from the present step S5 to the step S5 of 19 times before. Furthermore, N refers to the number of the values of the heights H, and N=20.

$$[ Formula 3 ]$$

$$H = 1 / N \times {\sum }_{j = 1}^{20} Hj \qquad ( 3 )$$

In the step S6, the determination unit 121 detects the height H of the surface of the washer liquid 20A a plurality of times as time passes, and determines the average of the heights H which were detected a plurality of times to be the height H of the surface of the washer liquid 20A.

The determination unit 121 increments a count value i (i=i+1) (a step S7).

The determination unit 121 waits for 250 ms (a step S8).

The determination unit 121 determines whether i≥20 (a step S9). That is, it determines whether the heights H have been detected 20 times or more.

When the determination unit 121 determines that i≥20 (S9: NO) does not hold, the flow is returned to the step S3, in order to detect the height H repeatedly. Moreover, when i is less than 20, the determination unit 121 skips over the process of the step S6, because necessary heights H data to find a moving average are not obtained.

When the determination unit 121 determines that i≥20 in the step S9 (S9: YES), whether a frozen state is present is determined according to Formula 2 (a step S10).

When the determination unit 121 determines that a frozen state is not present (S10: NO), a counter value f to determine freezing is set to zero (a step S11). That is, f=0.

The determination unit 121 makes the notifier 122 notify the moving average of the height H found in S6 to the ECU 11 of the vehicle system 10 (a step S12). Notifying only height H represents that freezing does not occur, but data representing that freezing does not occur (not freezing information) may be notified with the height H. When the process of the step S12 is finished, the determination unit 121 returns the flow to the step S3.

When the determination unit 121 determines that a frozen state is present in the step S10 (S10: YES), it increments a counter value f (a step S13). That is, f=f+1.

The determination unit 121 determines whether a frozen state is present for 20 consecutive times since the step S10 of 19 times past the present step S10 (S10: YES) (a step S14). As determinations are carried out every 250 ms, the process of the step S14 is a process to determine whether it is determined to be frozen (S10: YES) for the past five seconds.

When the determination unit 121 determines that a frozen state has not been present (S14: NO) consecutively for 20 times (S10: YES), the flow proceeds to step S12.

When the determination unit 121 determines that a frozen state has been present (S14: YES) consecutively for 20 times (S10: YES) in the step S14, it determines that the washer liquid 20A in the tank 20 is frozen, and makes the notifier 122 notify the ECU 11 the vehicle system 10 of the moving average of the heights H found in the step S6, and the data representing that freezing occurs (freezing information) (a step S15). Thus, a series of processes are finished.

Thus, the determination unit 121 finds the height H of the surface of the washer liquid 20A according to the height of the center of gravity of the washer liquid 20A by Formula 1. Moreover, the determination unit 121 determines whether the washer liquid 20A is frozen according to the detected surface height, the relative permittivity in a frozen state of the washer liquid 20A, and the capacitance of the electrostatic sensor 110, by Formula 2.

Consequently, the object amount detection device 100 which can determine the amount and state of the solidifiable liquid object (the washer liquid 20A) in the container (the tank 20) can be provided.

Furthermore, since the electrodes S0-S3 are plate-shaped electrodes having electrode pairs having triangular portions, which are obtained by dividing rectangles by their diagonals, and disposed on the lateral surface of the tank 20, however high the surface of the washer liquid 20A, vertically neighboring two electrodes (electrode pair) of the electrodes S0-S3 always coincide with the surface. Therefore, if there were a range which does not coincide with the surface, a portion in which the detected value does not appreciably change would occur, but since the surface always coincides with the electrodes, not-changing portions do not occur in detected values of the water level, and it is enabled to reduce a detected value of the water level according to lowering in water level, and the water level can be measured accurately.

Moreover, the determination unit 121 detects the surface of the washer liquid 20A according to the weighted average of a plurality of electrodes S0-S3, and determines the state of the surface position of the washer liquid 20A according to the detected surface height H of the washer liquid 20A, the capacitance of the electrostatic sensor 110, and the coefficient C according to the relative permittivity of the washer liquid 20A at a liquid state or at a solid state. Since the surface position is determined by the weighted average of the heights and the capacitances of a plurality of the electrodes, even if the permittivity of the solid and liquid are different, the surface height can be measured. Moreover, since the permittivities can be determined by the found height and the value of the electrostatic capacitance, and a relative permittivity of water (80.4) and a relative permittivity of ice (4.2) are largely different, the state of the washer liquid 20A can be detected accurately utilizing the difference of relative permittivities.

Moreover, since the electrodes S0-S3 have a plurality of electrode pairs and a plurality of electrode pairs are disposed vertically, even if the surface height of the washer liquid 20A varies continuously along a relatively vertically wide range, the height H and the state of the washer liquid 20A can be found.

Moreover, the surface height was calculated by reducing the capacitance of the washer liquid corresponding to the lower end of the electrostatic sensor. Therefore, even if the amount of the washer liquid 20A is small, the surface height H of the washer liquid 20A can be accurately detected.

Moreover, the surface height was calculated by disposing the electrode S0-S3 toward the tank 20, providing the reference electrode SR on the opposite surface across the shield electrode, and subtracting the capacitance of the reference electrode SR from the capacitances of the electrodes S0-S3 to correct to zero. Therefore, the surface height H of the washer liquid 20A can be accurately detected.

Moreover, since the determination unit 121 detects the surface height H of the washer liquid 20A a plurality of times as time passes, and determines the average of the heights H which were detected a plurality of times to be the height H of the surface of the washer liquid 20A, the height H can be accurately detected.

Moreover, the notifier 122, which notifies the ECU 11 of the vehicle system 10 of the freezing information when the determination unit 121 determines the state of the washer liquid 20A to be a frozen state, is included, the ECU 11 of the vehicle system 10 can be noticed of whether the washer liquid 20A is available. When the washer liquid 20A, which is used to clean particularly mud, dust, insects, etc. adhered to a camera or an optical sensor mounted on a self-driving vehicle or a vehicle with an automatic driving function mounting on which a vehicle system 10 such as ADAS is mounted, is frozen, the cleaning cannot be performed, thus, the provided object amount detection device 100 can contribute to safe drives of vehicles.

Moreover, in the present example, the surface position measuring process starts every predetermined period; however, it may start soon after a pump to spray the washer liquid has operated. Otherwise, short period measurements may be carried out after the pump to spray the washer liquid has operated, while usual measurements are at a long period. In this case, since measurements are carried out at moments when the surface changes, the measurements can be accurate and power consumption can be reduced.

Moreover, the water level measurement may be reduced or stopped when the vehicle is stopped temporarily and the idling is stopped. In this case, power consumption can be reduced when an electricity output is small.

Moreover, when an amount of noise which is measured by the sensor is small, the water level measurement may be reduced or stopped in determining that the vehicle is stopped.

Furthermore, when the vehicle is driven, the vehicle may be inclined to the horizontal surface, and in this case, the tank 20 may also be inclined and the surface of the washer liquid 20A may be inclined to the electrostatic sensor 110. The capacitance variations caused by such inclination may be corrected using the electrodes SS1, SS2.

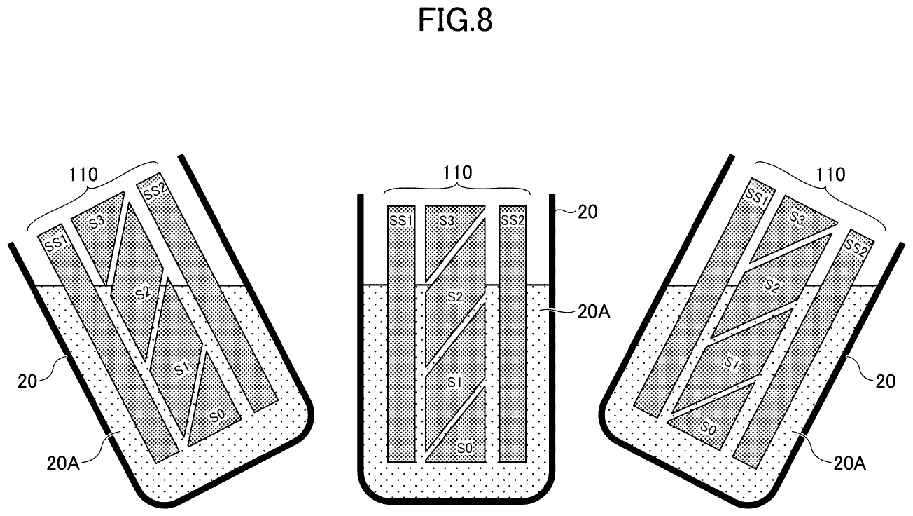

FIG. 8 is a drawing describing a method to correct a variation in capacitance accompanying an inclination. FIG. 8 shows states when the tank 20 is inclined and the positions of the portions of the electrodes SS1 and SS2 to be immersed in the washer liquid 20A. The electrodes SS1 and SS2 are examples of inclination detecting electrodes.

In this case, a gradient D (%) concerning the inclination of the tank 20 can be found by the following Formula 4.

$$[ Formula 4 ]$$

$$D ( \% ) = ( 1 - SS 1 / SS 2 ) \times 100 \qquad ( 4 )$$

The capacitances of the electrodes S0-S3 may be corrected using the gradient D, and the surface height H of the washer liquid 20A may be found according to the corrected capacitances. Furthermore, the state of the washer liquid 20A may be determined using the surface height H of the washer liquid 20A according to the corrected capacitances.

Specifically, the gradient D may be found according to Formula 4, in which section the surface of the washer liquid 20A within electrodes S0-S3 between the electrodes SS1 and SS2 may be corrected according to the gradient D, and the surface height H of the washer liquid 20A may be found according to the corrected capacitances. Subsequently, the state of the washer liquid 20A may be determined using the surface height H of the washer liquid 20A according to the corrected capacitances.

Note that, in the previous description, a plurality of electrodes were disposed vertically and the surface height of the washer liquid 20A was found continuously along a relatively vertically wide range; however, detection electrodes may be provided, for example every 10 mm, and heights of every 10 mm, that is, intermittent heights may be found.

Further, the present invention is not limited to these embodiments, but various variations and modifications may be made without departing from the scope of the present invention.

What is claimed is:

1. An object amount detection device comprising:
a container configured to contain a solidifiable liquid object;
an electrode extending in a vertical direction in the container, and configured to allow for detection of a change in capacitance accompanying a positional change in the vertical direction of a liquid surface of the object or an exterior surface of the object having been solidified; and
a processor configured to execute program instructions stored in a memory to detect continuously or intermittently, based on the capacitance of the electrode, a position of the liquid surface or the exterior surface of the object in the container, to obtain a permittivity of the object from the capacitance of the electrode, and to determine a state of the object based on the obtained permittivity.

2. The object amount detection device according to claim 1, wherein the electrode is a plate-shaped electrode having a plurality of electrode pairs having triangular portions, which are obtained by dividing rectangles by their diagonals, and disposed on a lateral surface of the container.

3. The object amount detection device according to claim 2, wherein the processor is configured to detect the liquid surface or the exterior surface of the object based on a weighted average of capacitances and positions of the plurality of the electrode pairs, and to determine the state of the object based on the detected position of the liquid surface or the exterior surface of the object, and a relative permittivity of the object in a liquid state or in a solid state.

4. The object amount detection device according to claim 2, wherein the plurality of electrode pairs are disposed along a vertical direction.

5. The object amount detection device according to claim 2, further comprising a reference electrode disposed on an opposite side from the electrode and the container across a shield electrode;
wherein the processor is configured to correct capacitances of the electrode pairs based on capacitance of the reference electrode.

6. The object amount detection device according to claim 2, wherein the processor is configured to set capacitance of one or more electrodes to zero when one of a plurality of electrode pairs has a capacitance equal to or less than a predetermined value, the one or more electrodes being situated higher than the one of the plurality of electrode pairs.

7. The object amount detection device according claim 2, wherein the processor is configured to correct capacitance of the electrode pairs when the position of the liquid surface or the exterior surface of the object is lower than or equal to a predetermined height.

8. The object amount detection device according to claim 2, wherein the processor is configured to calculate a liquid level height by factoring into calculation a capacitance of a virtual electrode pair the plurality of electrode pairs.

9. The object amount detection device according to claim 1, wherein the processor is configured to detect the position of the liquid surface or the exterior surface of the object a plurality of times as time passes, and to obtain an average of the positions of the liquid surface or the exterior surface of the object, detected a plurality of times, as the position of the liquid surface or the exterior surface of the object.

10. The object amount detection device according to claim 1, further comprising a notifier configured to notify an outside device of information that the object is in a frozen state when the processor determines that the state of the object is the frozen state.

11. The object amount detection device according to claim 1, wherein the object is a washer liquid for a vehicle.
